(19) United States
(12) Patent Application Publication
(10) Pub. No.: US 2024/0152986 A1
(43) Pub. Date: May 9, 2024

(54) SYSTEMS AND METHODS FOR OPTIMIZING SEARCH RESULTS

(71) Applicant: Airbnb, Inc., San Francisco, CA (US)

(72) Inventors: Malay Haldar, San Francisco, CA (US); Liwei He, San Francisco, CA (US); Tamara Tan, San Francisco, CA (US); Reid Anderson, San Francisco, CA (US)

(73) Assignee: Airbnb, Inc., San Francisco, CA (US)

(21) Appl. No.: 17/983,294

(22) Filed: Nov. 8, 2022

Related U.S. Application Data
(60) Provisional application No. 63/277,141, filed on Nov. 8, 2021.

(51) Int. Cl. G06Q 30/0601; G06Q 30/0201

(52) U.S. Cl. CPC G06Q 30/0627; G06Q 30/0201; G06Q 30/0641

(57) ABSTRACT

There is provided a method that includes receiving, from a client device, a search request for a set of listings, the search request including search parameters defining a search query. The method further includes generating a set of listings based on the search query and the search parameters and extracting price-indicative and non-price-indicative features. The method also includes computing a probability of booking and an estimate of quality, by inputting the price-indicative features and non-price-indicative features to trained machine learning models. The trained machine learning models predict (i) an affordability metric based on the price-indicative features and (ii) a quality metric based on the non-price-indicative features, separately. The affordability metric and the quality metric are representative of the probability of booking, and the quality metric is representative of the estimate of quality. The method further includes ranking the set of listings based on the booking probability and the quality estimate.

### RELATED APPLICATION

This application is related to U.S. Provisional Patent Application 63/277,141, filed Nov. 8, 2021, entitled “Systems and Methods for Optimizing Search Results,” which is incorporated by reference herein in its entirety.

### TECHNICAL FIELD

This application relates generally to special-purpose machines that manage data processing and improvements to such variants, and to the technologies by which optimized search results can be generated.

### BACKGROUND

As more and more people shop online, there is a need for companies to develop systems that provide reliable search results to its users to improve the overall user experience. Companies are continuously trying to analyze their user data to identify factors that can optimize search results for its users, but this analysis can be difficult. For example, systems for listing various items, such as listing units for rent, can track a large amount of user associated data including actions a user may perform at every listing. However, due to the large amount of user associated data and due to limitations in the type of data being collected, it is difficult to track specific user-associated actions at each listing in a manner that can objectively optimize listing search results to increase conversion rates for the searched items. Understanding these specific actions, and how to model them, can lead to significant optimization of search results rankings. As such, there is a need to quantify specific user-associated actions in order to optimize search results so as to increase the likelihood of conversion.

### SUMMARY

The disclosed implementations provide a method of optimizing a search listing. The method includes receiving, from a client device, a search request for a set of listings, the search request including search parameters defining a first search query. The method further includes generating a set of listings based on the first search query and the search parameters and extracting price-indicative features and non-price-indicative features for the set of listings. The method also includes computing a probability of booking and an estimate of quality, by inputting the price-indicative features and non-price-indicative features of the set of listings to trained machine learning models. The trained machine learning models predict (i) an affordability metric based on the price-indicative features and (ii) a quality metric based on non-price-indicative features, separately, wherein (i) the affordability metric and the quality metric are representative of the probability of booking and (ii) the quality metric is representative of the estimate of quality. The method further includes ranking the set of listings based on the probability of booking and the estimate of quality.

In some embodiments, the trained machine learning models includes a first trained deep neural network for predicting the affordability metric and a second trained deep neural network, distinct from the first trained deep neural network, for predicting the quality metric.

In some embodiment, computing the probability of booking comprises (i) inputting the price-indicative features to a first deep neural network that is trained to predict affordability, and (ii) inputting the non-price-indicative features to a second neural network that is trained to predict quality.

In some embodiments, ranking the set of listings comprises computing a final ranking score that weights the quality metric greater than the affordability metric and ranking the set of listings based on the final ranking score.

In some embodiments, ranking the set of listings comprises computing a final score that weights the quality metric approximately twice as much as the affordability metric and ranking the set of listings based on the final ranking score.

In some embodiments, for each respective listing of the set of listings, the non-price indicative features include at least one of: a location of the respective listing, a neighborhood of the respective listing, a number of bookings in the neighborhood of the respective listing, a number of bookings of the respective listing, a characteristic of the respective listing, a characteristic of bookings in the neighborhood of the respective listing and a number of clicks of the respective listing.

In some embodiments, a non-price indicative feature is a feature regarding a respective listing that is other than a monetary value associated with the respective listing.

In some embodiments, for each respective listing of the set of listings, the price indicative features include at least one of: a display price for the respective listing, a historical display price for the respective listing, a service fee for the respective listing and a cleaning fee for the respective listing.

In some embodiments, a price indicative feature is a feature regarding a respective listing that is a monetary value associated with the respective listing.

In some embodiments, the trained machine learning model is trained to output the quality metric based on price-indicative features in addition to non-price-indicative features of listings, at the time of training.

In some embodiments, computing a probability of quitting a search for the set of listings by inputting the set of listings to a trained machine learning model that is trained by logging last listing in search results viewed by one or more users; and ranking the set of listings further based on the probability of quitting.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram illustrating an exemplary optimized search system implemented in a networked environment, in accordance with some embodiments.

FIG. 2 is a block diagram illustrating the architecture of software used to implement the optimized search system, according to some embodiments.

FIG. 3 shows a machine as an example computer system with instructions to cause the machine to implement the optimized search system, according to some embodiments.

FIG. 4A illustrates an example user interface that shows search results ranked based on a probability of booking, according to some embodiments.

FIG. 4B illustrates an example user interface for search results ranked based on a probability of booking and an estimate of quality, according to some embodiments.

FIG. 5 shows a flow diagram of a method for performing flexible destination queries, according to some embodiments.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

In ranking theory, there are two observations that are made about rankings: attention decays monotonically with rank, and ordering listings by booking probability maximizes booking conversion rate.

For the first observation that attention decays monotonically with rank, it may be intuitively obvious that items at the top of a list get more attention, more views, more bookings, than those at the bottom. However, quantifying how the number of views and bookings of a listing is influenced by its position in search results is non-trivial. This is because the ranking model is actively trying to order the listings by relevance. Even if guests gave equal attention to all the positions in a search result, one may expect listings towards the top positions to have more views and bookings, simply because of higher relevance. One way to disentangle the influence of position and relevance of the listing is to randomly swap adjacent positions to equalize their relevance in aggregate, and then observe the influence of position alone. Doing this allows one to construct position discount curves which plot how the attention of guests decay with position. When plotted, the typical curve used in ranking shows a monotonically decreasing curve where higher positions get more attention compared to lower ones, because the decay of attention is monotonic.

The second observation that ordering listings by booking probability maximizes bookings may not hold true in all cases. For example, consider search result with listings {L₀, L₁, . . . , L_{N-1}}, where L₀ represents the topmost listing. Let P_{booking}(Lᵢ) represent the probability of booking for listing at position i, and Pₐₜₜₑₙₜᵢₒₙ(i) represent the probability that the guest gives attention to position i. From the first observation, we have, Pₐₜₜₑₙₜᵢₒₙ(i)>Pₐₜₜₑₙₜᵢₒₙ(j) if i<j. The second observation assumes that the total number of bookings is maximized when we order the listings sorted by booking probability, such that P_{booking}(Lᵢ)≥P_{booking}(Lⱼ) if i<j. Proving this observation may not hold true in all cases is fairly straightforward, and is based on demonstrating a contradiction. First, let

TotalBookings=Σᵢ₌₀^{N-1}Pₐₜₜₑₙₜᵢₒₙ(i)*P_{booking}(Lᵢ).

Now assume there is an ordering of listings where TotalBookings is maximized, but the ordering has a pair of listings that is not sorted by booking probability. So the order of listings has a pair such that P_{booking}(Lᵢ)<P_{booking}(Lⱼ) with i<j. Next the listings may be swapped at position i and j to make the order sorted by booking probability. The change in TotalBookings is given by:

$${P}_{a t t e n t i o n} ( i ) * {P}_{booking} ( {L}_{j} ) + {P}_{a t t e n t i o n} ( j ) * {P}_{booking} ( {L}_{i} ) - {P}_{a t t e n t i o n} ( i ) * {P}_{booking} ( {L}_{i} ) - {P}_{a t t e n t i o n} ( j ) * {P}_{b o o k i n g} ( {L}_{j} ) = {P}_{a t t e n t i o n} ( i ) * ( {P}_{b o o k i n g} ( {L}_{j} ) - {P}_{booking} ( {L}_{i} ) ) - {P}_{a t t e n t i o n} ( j ) * ( {P}_{b o o k i n g} ( {L}_{j} ) - {P}_{booking} ( {L}_{i} ) ) = ( {P}_{a t t e n t i o n} ( i ) - {P}_{a t t e n t i o n} ( j ) ) * ( {P}_{b o o k i n g} ( {L}_{j} ) - {P}_{b o o k i n g} ( {L}_{i} ) )$$

$$Since {P}_{a t t e n t i o n} ( i ) > {P}_{a t t e n t i o n} ( j ) and {P}_{b o o k i n g} ( {L}_{j} ) > {P}_{b o o k i n g} ( {L}_{i} ) , the$$

difference in TotalBookings obtained by swapping is strictly positive. Therefore, the previous TotalBookings which violated the sorted by booking probability order couldn't have been the maximum. This proves the second observation alone does not always hold true in all cases. In practice, for small perturbations against sorting by booking probability, the drop in bookings may be small enough to escape detection in an online A/B test. But the drop has been observed. The simplicity of the second observation makes it very robust. Since moving to this framework, the framework has been used in hundreds of experiments. Successful model iterations have progressively refined the booking probability estimates, but operated within the second observation.

Note that to apply the second observation to ranking, one may need an accurate estimate of P_{booking}(Lᵢ)>P_{booking}(Lⱼ), and not accurate estimates of P_{booking}(Lᵢ) and P_{booking}(Lⱼ) themselves. This distinction may be the reason why pairwise probabilities which represent P_{booking}(Lᵢ)>P_{booking}(Lⱼ), are used instead of pointwise probabilities which stand for P_{booking}(Lᵢ) and P_{booking}(Lⱼ). A caveat here is that the second law assumes the booking probabilities of the listings to be independent of each other. In theory, the booking probabilities could depend on each other, and removing some redundant listings could increase diversity and improve total bookings. Another caveat is that the second law puts equal emphasis on sortedness throughout the list. One could argue, being sorted by booking probability near the top of the list matters more than towards the bottom. While this makes sense in theory, in practice such a distinction has been found to not be material. Frameworks, such as Lamda, rank and loss functions explicitly optimizing top of the list more than the bottom have not shown any increase in total bookings compared to keeping the list sorted throughout.

The second observation may also be shown to not hold true based on a GBV ranker experiment. Normally in ranking, one orders the listing by log(P_{booking}(Lᵢ), which is the same as ordering by P_{booking}(Lᵢ), since log is monotonic. In the GBV ranker experiment, instead of ranking by P_{booking}(Lᵢ) we rank by P_{booking}(Lᵢ)*price(Lᵢ), or equivalently by log(P_{booking}(Lᵢ))+log(price(Lᵢ)). The listings in the GBV ranker experiment are no longer sorted by booking probabilities. The NDCG metric, which measures the sortedness of the results show a drop of ˜1%. This is expected to produce a clear drop in bookings, in accordance with the second law of ranking. Yet, the bookings metric is neutral in the experiment, meaning the second observation does not always hold true.

To observe where the second law may not be optimized in at least some embodiments, let the first law be interpreted as Pₐₜₜₑₙₜᵢₒₙ(i)>Pₐₜₜₑₙₜᵢₒₙ(j) if i<j. This interpretation implicitly makes the assumption that probability of attention, Pₐₜₜₑₙₜᵢₒₙ, is a function of position alone. In reality, this assumption turns out to be a mere approximation. In the context of web search, it has been observed that a more accurate model is where the attention at position i is dependent on all the listings at positions above, from 0 through i−1. This is known as the cascade model of attention.

To adapt the cascade model to web-based searches, assume that guests examine the listings from top to bottom, and at each listing perform one of three actions:
Book the listing L, with probability P_{booking}(L)
Skip to the next listing, with probability Pₛₖᵢₚ(L)
Quit the results altogether, with probability P_{quit}(L)
For any listing L, P_{booking}(L)+Pₛₖᵢₚ(L)+P_{quit}(L)−1.

Next, one may examine how total bookings can be expressed in terms of P_{booking}(L), Pₛₖᵢₚ(L) and P_{quit}(L). In ranking one may essentially construct a comparator. Given two listings Lₐ and L_{b}, the comparator determines whether ordering {Lₐ, L_{b}} leads to more bookings or the ordering {L_{b}, Lₐ} does. Extending the conclusions drawn to lists of arbitrary length is straightforward.

For the ordering {Lₐ, L_{b}}, total bookings denoted by Bookings_{ab} is given by:

$${Bookings}_{ab} = {P}_{b o o k i n g} ( {L}_{a} ) + {P}_{s k i p} ( {L}_{a} ) * {P}_{b o o k i n g} ( {L}_{b} ) = {P}_{b o o k i n g} ( {L}_{a} ) + ( 1 - {P}_{b o o k i n g} ( {L}_{a} ) - {P}_{q u i t} ( {L}_{a} ) ) * {P}_{b o o k i n g} ( {L}_{b} ) = {P}_{b o o k i n g} ( {L}_{a} ) + {P}_{b o o k i n g} ( {L}_{b} ) - {P}_{b o o k i n g} ( {L}_{a} ) * {P}_{b o o k i n g} ( {L}_{b} ) - {P}_{q u i t} ( {L}_{a} ) * {P}_{b o o k i n g} ( {L}_{b} )$$

Similarly, for the ordering {L_{b}, Lₐ}, total bookings denoted by Bookings_{ba} is given by:

$${Bookings}_{ba} = {P}_{b o o k i n g} ( {L}_{a} ) + {P}_{b o o k i n g} ( {L}_{b} ) - {P}_{b o o k i n g} ( {L}_{a} ) * {P}_{b o o k i n g} ( {L}_{b} ) - {P}_{q u i t} ( {L}_{b} ) * {P}_{b o o k i n g} ( {L}_{a} ) .$$

The condition that the order {Lₐ, L_{b}} gets more bookings than {L_{b}, Lₐ} can be written as:

Bookings_{ab}>Bookings_{ba}

P_{booking}(Lₐ)*P_{quit}(L_{b})>P_{booking}(L_{b})*P_{quit}(Lₐ)

P_{booking}(Lₐ)/P_{quit}(Lₐ)>P_{booking}(L_{b})/P_{quit}(L_{b})

Note that if one assumes P_{quit}(Lₐ)=P_{quit}(L_{b})=k, where k is some constant independent of the listings, then the condition reduces to P_{booking}(Lₐ)>P_{booking}(L_{b}) which is the second observation. Accordingly, the second observation of ranking may not be wrong. Instead, the second observation may happen to be an approximation of reality, and perhaps an accurate one at that, relying on the assumption that propensity of users to quit is completely explained by the position in search results.

A key question is understanding P_{quit}, the probability that the guest will quit after looking at the listing. One assumption is that users nowadays are habitually trained to deal with infinite lists. The way users cope with infinite lists is to keep examining the list until a certain threshold of relevance. Once they see relevance fall below the threshold, they assume everything below will be even worse and quit.

Another assumption is that users implement a cascaded attention model in web searches. The cascaded attention model of web search assumes that users examine the list from the top and click at the first result that satisfies relevance. In a cascade model, it is assumed that guests examine the list from the top and quit at the first result that has unsatisfactory relevance. Further, the concept of relevance is not the same as booking probability, which is a combination of relevance and affordability.

The challenge with a cascade model is that one doesn't get an explicit label when users quit, so it's difficult to directly train a model to infer P_{quit}.

To make progress, an assumption is made that the probability that a guest quits after examining a listing is inversely proportional to the inherent quality of the listing:

$$\frac{1}{{P}_{q u i t} ( L )} ≡ quality ( L ) .$$

Higher the quality of the listing, lower the probability that the guest will quit. To emphasize once more, this may be different from the booking probability of a listing which is a combination of quality and affordability. A listing can be of low quality, but have high booking probability if it is very competitively priced.

But quality(L) can still be an abstract quantity, making it difficult to infer. Some experiments give a strong indication that price(L) may be a proxy for quality(L) to a large extent. Specifically, if one assumes price is a proxy for quality, one can rewrite

$$\frac{1}{{P}_{q u i t} ( {L}_{a} )} ≡ quality ( {L}_{a} ) ≡ price ( {L}_{a} )$$

then the condition for maximizing bookings

P_{booking}(Lₐ)/P_{quit}(Lₐ)>P_{booking}(L_{b})/P_{quit}(L_{b})

can be rewritten as,

P_{booking}(Lₐ)*price(Lₐ)>P_{booking}(L_{b})*price(L_{b})

or,

log(P_{booking}(Lₐ))+log(price(Lₐ))>log(P_{booking}(L_{b}))+log(price(L_{b})).

This provides a framework to understand why adding log(price(L)) to the ranking score is bookings neutral. Ordering the listings by log(P_{booking}(L)) alone is a greedy approach that leads to the second observation. Ordering the listings by log(P_{booking}(L))−log(P_{quit}(L)) leads to a non-greedy approach, where listings may not maximize booking probability for themselves, but may maximize the overall probability of booking for the guest. And log(price(L)) may approximate −log(P_{quit}(L)) giving an alternate path to reach the same number of bookings as sorting by log(P_{booking}(L)) does.

Note this approach predicts that online one should observe guests skipping more results, given the same number of bookings. If the two orderings {Lₐ, L_{b}} and {L_{b}, Lₐ} result in the same number of bookings, then one can write

P_{booking}(Lₐ)+Pₛₖᵢₚ(Lₐ)*P_{booking}(L_{b})=P_{booking}(L_{b})+Pₛₖᵢₚ(L_{b})*P_{booking}(Lₐ)

or,

P_{booking}(Lₐ)/P_{booking}(L_{b})=(1−Pₛₖᵢₚ(Lₐ))/(1−Pₛₖᵢₚ(L_{b})).

Therefore, if P_{booking}(Lₐ)>P_{booking}(L_{b}), or P_{booking}(Lₐ)/P_{booking}(L_{b})>1 then, (1−Pₛₖᵢₚ(Lₐ))/(1−Pₛₖᵢₚ(L_{b}))>1 or, Pₛₖᵢₚ(L_{b})>Pₛₖᵢₚ(Lₐ). Hence in the ranking where we are not ordering by P_{booking}, one would observe more skips. Thus, ranking using a greater weighting for quality may be more optimal.

When ranking for quality, although price may be a proxy for listing quality, directly using it in ranking may be problematic. If one directly ranks listings by log(P_{booking}(L))+log(price(L)), then hosts can simply increase their rank by increasing the listing price. However, research has shown that the increase from log(price(L)) more than offsets any lowering in log(P_{booking}(L)) due to increasing prices. Therefore, a key question remains regarding whether there is a way to estimate quality(L) without resorting to the listing price.

To estimate the listing quality, an assumption can be made that the booking decision by a guest is the result of trying to balance two factors: the listing quality (the benefit), against the affordability of the listing (the cost) to better model user actions that are not easily tracked during operation.

In some embodiments of the invention described herein, estimates of the listing quality are determined to optimize search results for such listings, without compromising value.

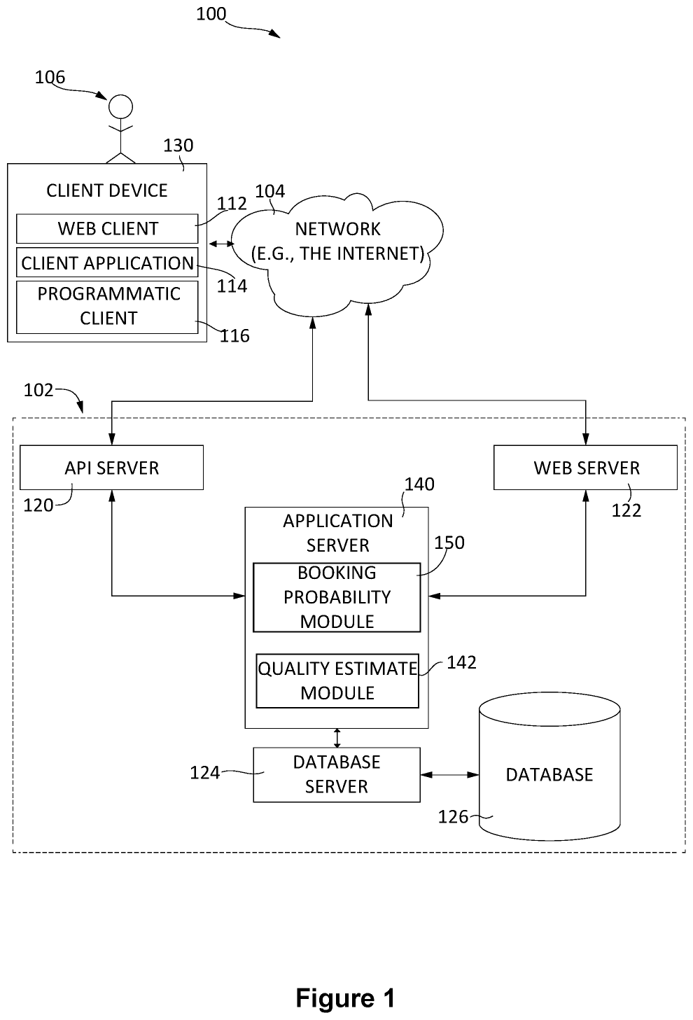

FIG. 1 shows a block diagram of a network architecture 100 for an optimized search system according to some embodiments. FIG. 1 illustrates, for example, a web client 112 (e.g., a browser), client application(s) 114, and a programmatic client 116 executing on a client device 130. The client device 130 includes a web client 112, client application(s) 114, and a programmatic client 116 alone, together, or in any suitable combination. Although FIG. 1 shows one client device 130, in some embodiments, the network architecture 100 comprises multiple client devices.

In some embodiments, the client device 130 comprises a computing device that includes at least a display and communication capabilities that provide access to a networked system 102 via a network 104. The client device 130 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultra-book, netbook, laptop, desktop, multi-processor system, microprocessor-based or programmable consumer electronic, game consoles, set-top box (STB), network personal computer (PC), mini-computer, and so forth. In some embodiments, the client device 130 comprises one or more of a touch screens, accelerometer, gyroscope, biometric sensor, camera, microphone, Global Positioning System (GPS) device, and the like.

The client device 130 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or any suitable combination thereof.

In some embodiments, the client device 130 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and reservation applications for temporary stays at hotels, motels, or residences managed by other end-users (e.g., a posting end-user who owns a home and rents out the entire home or private room). In some embodiments, the client application(s) 114 include various components operable to present information to the user and communicate with the networked system 102. In some embodiments, if an e-commerce site application is included in the client device 130, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the e-commerce site application is not included in the client device 130, the client device 130 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via a programmatic interface provided by an Application Program Interface (API) server 120.

Users (e.g., user 106) comprise a person, a machine, or other means of interacting with the client device 130. In some embodiments, the user 106 is not part of the network architecture 100, but interacts with the network architecture 100 via the client device 130 or another means. For instance, the user 106 provides input (e.g., touch screen input or alphanumeric input) to the client device 130 and the input is communicated to the networked system 102 via the network 104. In this instance, the networked system 102, in response to receiving the input from the user 106, communicates information to the client device 130 via the network 104 to be presented to the user 106. In this way, the user 106 can interact with the networked system 102 using the client device 130.

The API server 120 and the web server 122 are coupled to, and provide programmatic and web interfaces respectively to, one or more application server(s) 140. The application server 140 is configured to provide optimized search results to a client device 130 in response to a search request from the client device 130. The application server(s) 140 include a quality module 142 (also referred to herein as a “quality estimate module”) and a probability module 150 (also referred to herein as a “booking probability module” or an “affordability module”) each configured to derive certain metrics that can be used to rank search results in an optimized manner as compared to conventional ranking techniques. The quality module 142 and/or the probability module 150 may comprise one or more modules or applications and each of which can be embodied as hardware, software, firmware, or any combination thereof to facilitate optimizing the search results for the client device 130. The application server(s) 140 are, in turn, shown to be coupled to one or more database server(s) 124 that facilitate access to one or more information storage repositories or database(s) 126. In some embodiments, the database(s) 126 are storage devices that store information to be posted (e.g., inventory, image data, catalog data) to the quality module 142. The database(s) 126 also stores digital goods information in accordance with some embodiments.

The quality module 142 generates an estimate of quality for each listing based on, or as a function of, quality features. Examples of quality features include a location of the respective listing, a neighborhood of the respective listing, a number of bookings in the neighborhood of the respective listing, a number of bookings of the respective listing, a characteristic of the respective listing, a characteristic of bookings in the neighborhood of the respective listing and a number of clicks of the respective listing. In some embodiments, the quality features are objective features based on unbiased facts not influenced by personal feelings, interpretations (e.g., star ratings) or prejudices. In some embodiments, the quality features are non-price indicative features. A non-price indicative feature may be a feature regarding a respective listing that is other than a monetary value associated with the respective listing.

The probability module 150 generates a probability of booking for each listing based on, or a function of, probability features. Examples of probability features include quality features (e.g., the quality features described above in reference to the quality module 142) and affordability features. Examples of affordability features includes a display price for the respective listing, a historical display price for the respective listing, a service fee for the respective listing and a cleaning fee for the respective listing. In some embodiments, the affordability features are price indicative features. A price indicative feature may be a feature regarding a respective listing that is a monetary value associated with the respective listing.

While the network architecture 100 shown in FIG. 1 employs a client-server architecture, the present inventive subject matter is, of course, not limited to such an architecture, and can equally be implemented in a distributed, or peer-to-peer, architecture system, for example. The various components of the applications server(s) 140 (e.g., the quality module 142 and the probability module 150) may also be implemented as standalone software programs, which do not necessarily have networking capabilities.

Although the quality module 142 and the probability module 150 are shown in FIG. 1 as components of the networked system 102, it will be appreciated that, in alternative embodiments, each may be a component in a web service that is separate and distinct from the networked system 102. The quality module 142 and the probability module 150 can each be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124.

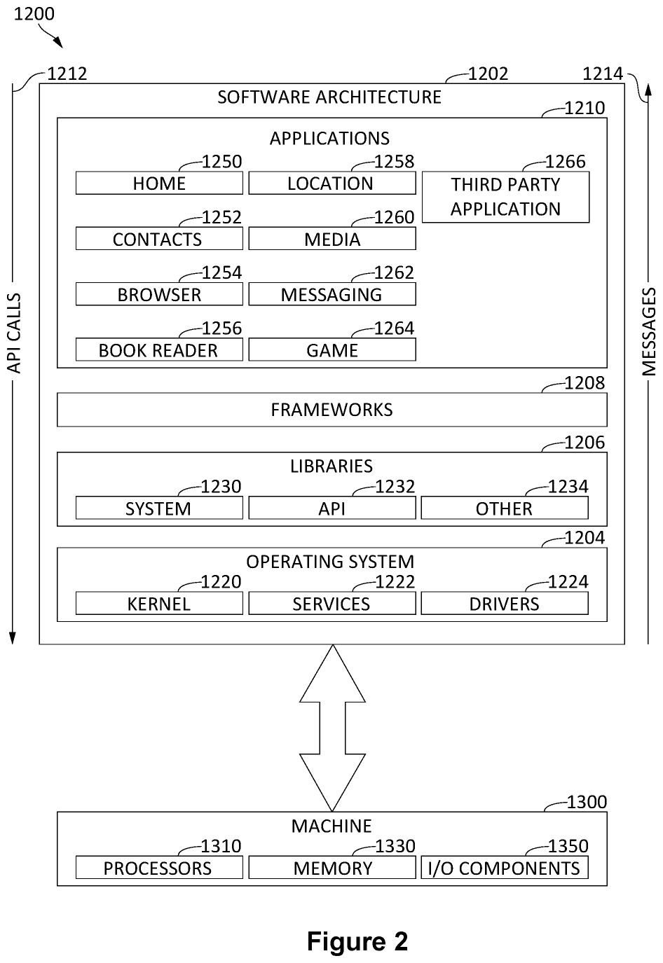

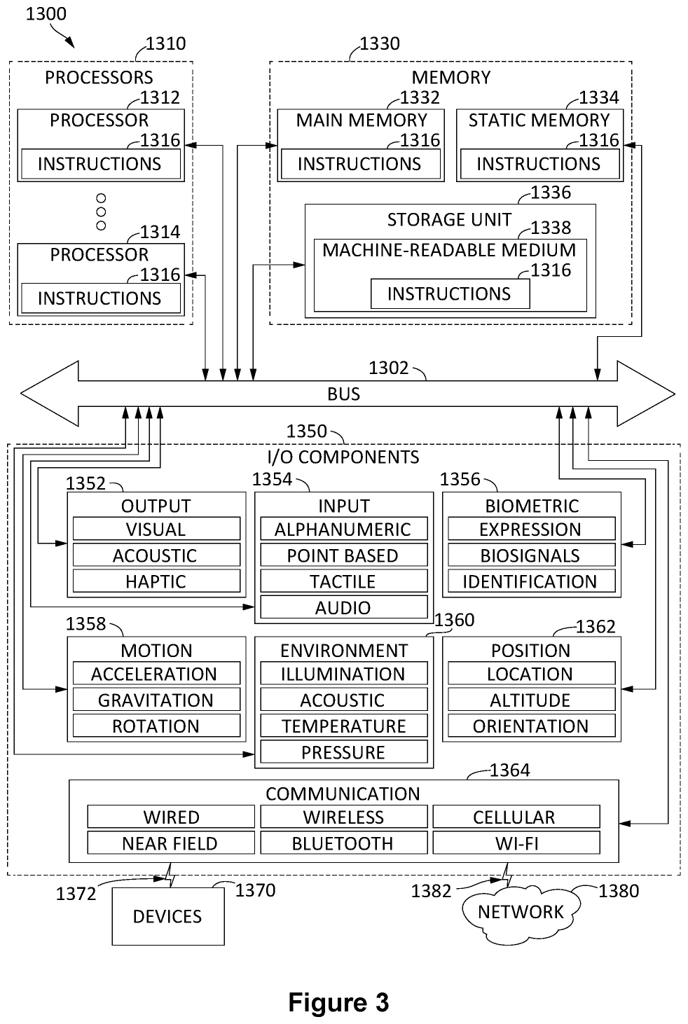

FIG. 2 is a block diagram 1200 illustrating an architecture of software 1202, which can be installed on any one or more of the devices described above. FIG. 2 is merely a non-limiting example of a software architecture, and it will be appreciated that many other architectures can be implemented to facilitate the functionality described herein. In various embodiments, software 1202 is implemented by hardware such as a machine 1300 (further described in FIG. 3) that includes processors 1310, memory 1330, and input/output (I/O) components 1350. In this example architecture, the software 1202 can be conceptualized as a stack of layers where each layer may provide a particular functionality. For example, the software 1202 includes layers such as an operating system 1204, libraries 1206, frameworks 1208, and applications 1210. Operationally, the applications 1210 invoke API calls 1212 through the software stack and receive messages 1214 in response to the API calls 1212, consistent with some embodiments.

In various implementations, the operating system 1204 manages hardware resources and provides common services. The operating system 1204 includes, for example, a kernel 1220, services 1222, and drivers 1224. The kernel 1220 acts as an abstraction layer between the hardware and the other software layers, consistent with some embodiments. For example, the kernel 1220 provides memory management, processor management (e.g., scheduling), component management, networking, and security settings, among other functionalities. The services 1222 can provide other common services for the other software layers. The drivers 1224 are responsible for controlling or interfacing with the underlying hardware, according to some embodiments. For instance, the drivers 1224 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 1206 provide a low-level common infrastructure utilized by the applications 1210. The libraries 1206 can include system libraries 1230 (e.g., C standard library) that can provide functions such as memory allocation functions, string manipulation functions, mathematic functions, and the like. In addition, the libraries 1206 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3(MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1206 can also include a wide variety of other libraries 1234 to provide many other APIs to the applications 1210.

The frameworks 1208 provide a high-level common infrastructure that can be utilized by the applications 1210, according to some embodiments. For example, the frameworks 1208 provide various graphic user interface (GUI) functions, high-level resource management, high-level location services, and so forth. The frameworks 1208 can provide a broad spectrum of other APIs that can be utilized by the applications 1210, some of which may be specific to a particular operating system or platform.

In some embodiments, the applications 1210 include a home application 1250, a contacts application 1252, a browser application 1254, a book reader application 1256, a location application 1258, a media application 1260, a messaging application 1262, a game application 1264, and a broad assortment of other applications such as a third-party application 1266. According to some embodiments, the applications 1210 are programs that execute functions defined in the programs. Various programming languages can be employed to create one or more of the applications 1210, structured in a variety of manners, such as object-oriented programming languages (e.g., Objective-C, Java, or C++) or procedural programming languages (e.g., C or assembly language). In a specific example, the third-party application 1266 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1266 can invoke the API calls 1212 provided by the operating system 1204 to facilitate the functionality described herein.

FIG. 3 illustrates a diagrammatic representation of a machine 1300 in the form of a computer system within which a set of instructions may be executed for causing the machine to perform any one or more of the methodologies discussed herein, according to some embodiments. Specifically, FIG. 3 shows a diagrammatic representation of the machine 1300 in the example form of a computer system, within which instructions 1316 (e.g., software, a program, an application, an applet, an app, or other executable code) for causing the machine 1300 to perform any one or more of the methodologies discussed herein may be executed. The instructions 1316 transform the general, non-programmed machine 1300 into a particular machine 1300 programmed to carry out the described and illustrated functions in the manner described. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a PC, a tablet computer, a laptop computer, a netbook, an STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1316, sequentially or otherwise, that specify actions to be taken by the machine 1300. Further, while only a single machine 1300 is illustrated, the term “machine” shall also be taken to include a collection of machines 1300 that individually or jointly execute the instructions 1316 to perform any one or more of the methodologies discussed herein.

The machine 1300 may include processors 1310, memory 1330, and I/O components 1350, which may be configured to communicate with each other such as via a bus 1302. In some embodiments, the processors 1310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1312 and a processor 1314 that may execute the instructions 1316. The term “processor” is intended to include multi-core processors that may comprise two or more independent processors (sometimes referred to as “cores”) that may execute instructions contemporaneously. Although FIG. 3 shows multiple processors 1310, the machine 1300 may include a single processor with a single core, a single processor with multiple cores (e.g., a multi-core processor), multiple processors with a single core, multiple processors with multiples cores, or any combination thereof.

The memory 1330 may include a main memory 1332, a static memory 1334, and a storage unit 1336, all accessible to the processors 1310 such as via the bus 1302. The main memory 1332, the static memory 1334, and storage unit 1336 store the instructions 1316 embodying any one or more of the methodologies or functions described herein. The instructions 1316 may also reside, completely or partially, within the main memory 1332, within the static memory 1334, within the storage unit 1336, within at least one of the processors 1310 (e.g., within the processor's cache memory), or any suitable combination thereof, during execution thereof by the machine 1300.

The I/O components 1350 may include a wide variety of components to receive input, provide output, produce output, transmit information, exchange information, capture measurements, and so on. The specific I/O components 1350 that are included in a particular machine will depend on the type of machine. For example, portable machines such as mobile phones will likely include a touch input device or other such input mechanisms, while a headless server machine will likely not include such a touch input device. It will be appreciated that the I/O components 1350 may include many other components that are not shown in FIG. 13. The I/O components 1350 are grouped according to functionality merely for simplifying the following discussion and the grouping is in no way limiting. In various embodiments, the I/O components 1350 may include output components 1352 and input components 1354. The output components 1352 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1354 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some embodiments, the I/O components 1350 may include biometric components 1356, motion components 1358, environmental components 1360, or position components 1362, among a wide array of other components. For example, the biometric components 1356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1358 may include acceleration sensor components (e.g., accelerometer), gravitation sensor components, rotation sensor components (e.g., gyroscope), and so forth. The environmental components 1360 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1362 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1350 may include communication components 1364 operable to couple the machine 1300 to a network 1380 or devices 1370 via a coupling 1382 and a coupling 1372, respectively. For example, the communication components 1364 may include a network interface component or another suitable device to interface with the network 1380. In further examples, the communication components 1364 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1370 may be another machine or any of a wide variety of peripheral devices (e.g., a peripheral device coupled via a USB).

Moreover, the communication components 1364 may detect identifiers or include components operable to detect identifiers. For example, the communication components 1364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1364, such as location via Internet Protocol (IP) geolocation, location via Wi-Fi® signal triangulation, location via detecting an NFC beacon signal that may indicate a particular location, and so forth.

The various memories (i.e., 1330, 1332, 1334, and/or memory of the processor(s) 1310) and/or storage unit 1336 may store one or more sets of instructions and data structures (e.g., software) embodying or utilized by any one or more of the methodologies or functions described herein. These instructions (e.g., the instructions 1316), when executed by processor(s) 1310, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various embodiments, one or more portions of the network 1380 may be an ad hoc network, an intranet, an extranet, a VPN, an LAN, a WLAN, a WAN, a WWAN, an MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1380 or a portion of the network 1380 may include a wireless or cellular network, and the coupling 1382 may be a Code Division Multiple Access (CDMA) connection, a Global System for Mobile communications (GSM) connection, or another type of cellular or wireless coupling. In this example, the coupling 1382 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1316 may be transmitted or received over the network 1380 using a transmission medium via a network interface device (e.g., a network interface component included in the communication components 1364) and utilizing any one of a number of well-known transfer protocols (e.g., hypertext transfer protocol (HTTP)). Similarly, the instructions 1316 may be transmitted or received using a transmission medium via the coupling 1372 (e.g., a peer-to-peer coupling) to the devices 1370. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1316 for execution by the machine 1300, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

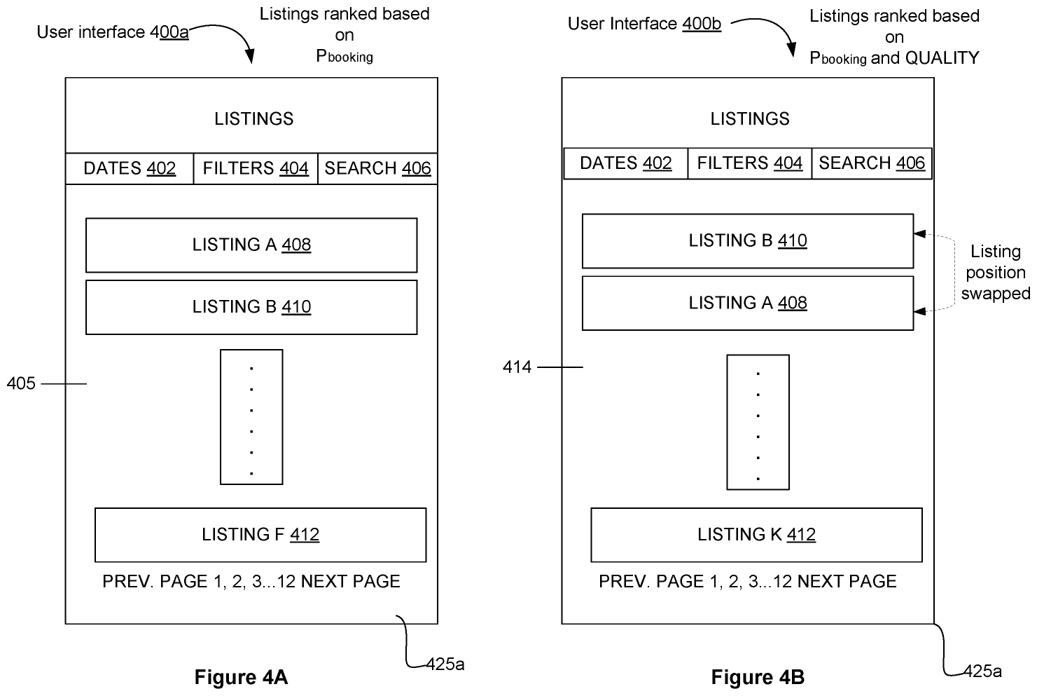

FIG. 4A illustrates an example user interface 400a(e.g., a mobile application user interface, a web browser user interface) for search listings ranked based on maximizing the probability of booking P_{booking}(L), according to some embodiments. As explained previously, when users examine the listings from top to bottom, the users perform one of three actions at each listing: (i) book the listing L, with probability P_{booking}(L), (ii), skip to the next listing, with probability Pₛₖᵢₚ(L) and (iii) quit the results altogether, with probability P_{quit}(L). As explained previously, ranking listings based on only the probability that a user will book a listing P_{booking}(L) may not fully represent optimized search results. For example, an optimized search listing may provide a higher likelihood of a user booking a listing (e.g., listing A 408) and a lower likelihood of a user quitting the results altogether.

As illustrated, the user interface 400a includes a dates field 402, a filters menu element 404 (e.g., place type, amenities) and a search field 406. In an example scenario, a user enters a listings query into the search field 406, such as a search for temporary housing in a specific location (e.g., San Diego). The user can customize the query directly using terms input into the search field 406 and add filters listed via selection of the filters menu element 404. Further, the user may select dates using the dates drop-down element 402 to select a specific date range for the temporary stay. For example, the user can select the dates drop-down element 402 and a pop-up calendar (not depicted in FIG. 4A) to specify the stay in San Diego is to be specifically from Dec. 16, 2021 to Dec. 18, 2021. Upon submitting the query (e.g., via selection of the search button 406, or automatically upon selecting dates drop-down element 402), the listings are displayed in the listings results area 405. The user can then select the listings or navigate to additional pages via page navigational element 425a.

As described above, the generated listing 405 is ranked based on a maximization of a perceived probability of a user booking a respective listing. As such, the results appearing higher in the list have a perceived greater probability of a user booking a respective listing as compared to results that are lower on the list. The generated listing 405, based on at least the users search query and filters selected, ranks listing A 408 first and listing B 410 second even though listing B may have substantially better quality characteristics as compared to listing A and a higher likelihood of booking conversion in practice. That may be because a perceived probability of a user booking a respective listing that is based on a blend of affordability features and quality features. That is to say, the affordability features and quality features, together without clear delineation on weightings, determine a perceived probability of booking a listing that may not be optimized. As explained above, the lack of clear delineation in weightings may inherently lead to an inability to specifically identify individual characteristics that specifically track quality of a listing since they have been conflated with affordability characteristics. As described previously, specifically tracking characteristics related to estimates of quality, and independently weighting the characteristics, accordingly, may provide optimized search results and decrease the likelihood of a user quitting from their search results.

FIG. 4B illustrates an example user interface 400b for listing results, ranked based on, or a function of, P_{booking}(L) and also a separate and independent factor the estimate of quality, according to some embodiments. Separating P_{booking}(L) from the estimate of quality allows the ranked search results determined from the machine to account for, and properly weight, price indicative features and non-price indicative features, separately and independently. As shown, Listing B 410 is now ranked first, whereas in FIG. 4A, Listing A 408 was ranked first. User interface 400b has similar features as the user interface 400a described above in reference to FIG. 4A. User interface 400b may be generated based on a method of optimizing a search listing using a probability of booking (e.g., a probability computed by the probability module 150) and a quality estimate (e.g., an estimate computed by the quality module 142).

A probability of booking and an estimate of quality may each be independently computed (e.g., by the server 140) using trained machine learning models. The trained machine learning models may include various deep neural networks for generating the ranked list. In some embodiments, the trained machine learning models may include at least one of: a first trained deep neural network for predicting an affordability metric using affordability features described herein and a second trained deep neural network for predicting a quality metric using quality features described herein. For example, an embodiment of an optimized search system described herein may use two separate networks: (i) an affordability network DNN(affordability), and (ii) a quality network DNN(quality), where DNN represents a deep neural network.

The machine learning models may predict an affordability metric based on price-indicative features. Examples of price-indicative features include a display price for the respective listing, a historical display price for the respective listing, a service fee for the respective listing and a cleaning fee for the respective listing.

The machine learning models may predict a quality metric based on the non-price-indicative features, separately and independently from affordability. Examples of non-price indicative features include a location of the respective listing, a neighborhood of the respective listing, a number of bookings in the neighborhood of the respective listing, a number of bookings of the respective listing, a characteristic of the respective listing, a characteristic of bookings in the neighborhood of the respective listing and a number of clicks of the respective listing.

The affordability metric and the quality metric together may be representative of the probability of booking. The quality metric separately and independent of the affordability metric may be representative of the estimate of quality.

In some embodiments, the probability of booking is computed by (i) inputting the price-indicative features to a first deep neural network that is trained to predict affordability and (ii) inputting the non-price-indicative features to a second neural network that is trained to predict quality. For example, the probability of booking can be represented as log(P_{booking}(L))=DNN(quality)+DNN(affordability). Because there are numerous features that are indicative of price and other features, and relationships between the different features may not be well-known and are complex, neural networks can be very useful because they help learn and model non-linear and complex relationships. Neural network weights are adjusted automatically based on observed data, and with more data, the accuracy of the prediction can be improved.

The set of listings may be ranked based on, or a function of: (i) the probability of booking and (ii) the estimate of quality, and displayed in a user interface (e.g., the user interface 400b). Ranking the set of listings includes computing a final ranking score. In some embodiments, the final ranking score weights the quality metric greater than the affordability metric and ranking the set of listings based on the final ranking score. In other embodiments, ranking the set of listings includes computing a final score that weights the quality metric approximately twice as much as the affordability metric and ranking the set of listings based on the final ranking score.

In some embodiments, an optimized ranking formulation may be a function of the

$$log ( {P}_{b o o k i n g} ( L ) ) - log ( {P}_{q u i t} ( L ) ) ≃ log ( {P}_{b o o k i n g} ( L ) ) + quality ( L ) ≃ log ( {P}_{b o o k i n g} ( L ) ) + DNN ( quality )$$

Since the booking probability prediction itself is log(P_{booking}(L)=DNN(quality)+DNN(affordability), the sum log(P_{booking}(L))+DNN(quality) can be rewritten as,

$$log ( {P}_{b o o k i n g} ( L ) ) + DNN ( quality ) = DNN ( quality ) + DNN ( affordability ) + DNN ( quality ) = 2 * DNN ( quality ) + DNN ( affordability )$$

While the estimate of quality is weighted twice that of affordability, in some embodiments, other weightings may be used to optimize search listings, so long as the estimate of quality is weighted higher than affordability.

To confirm that ordering the listings by P_{booking}(l)*quality(L) achieves the goal of increasing the quality of booked listings, an online A/B experiment was conducted. The control was a ranker optimizing the number of bookings, ordering listings by the best estimate of P_{booking}(l). The treatment was a ranker ordering listings by P_{booking}(l)*quality(L). Various quality attributes of the listings booked were compared across treatment and control. This online A/B experiment revealed a definite increase in the quality of booked listings, as indicated in the following metrics:
Bookings for top listing hosts increased +1.3% with p-value 4E-7.
an increase in both review counts (+1.4%, p-value 5E-6), and review ratings (+0.96%, p-value 2E-8) of booked listings.
the number of listings on the first page that were within the boundaries of a preferred location for a user (an indication of higher result relevance) increased by +3.2%, p-value 1E-15.
Bookings of listings where guests have the whole space to themselves increased by +0.84%, p-value 3E-6.
5-star reviews increased +0.36%, p-value 0.01 and there was a decrease in 3-star reviews or lower by −2.4%, p-value 0.01.

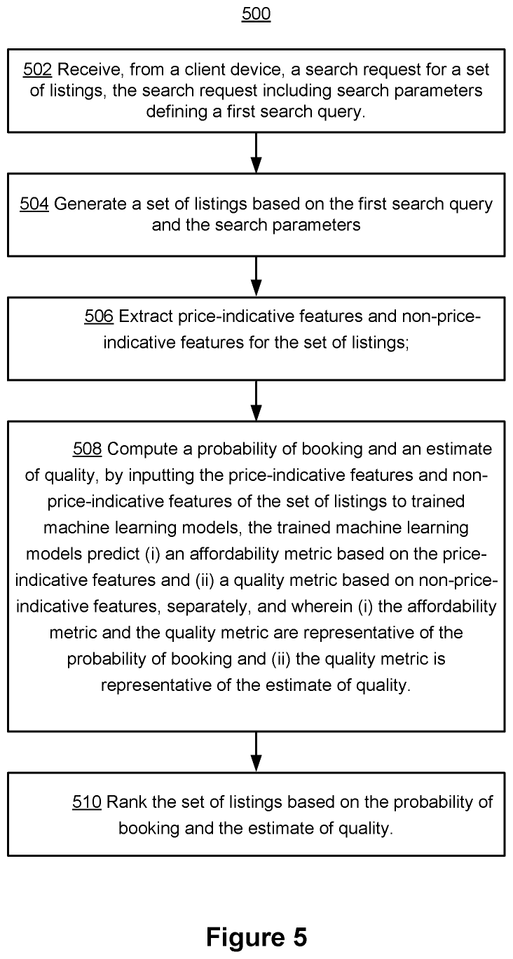

FIG. 5 shows a flow diagram of a method (500) for optimizing a search listing (e.g., listings 400b in FIG. 4B), according to some embodiments. In some embodiments, the steps of the method 500 are performed by a computer (e.g., the application server 140). In some embodiments, the steps of the method 500 are performed by a system (e.g., the networked system 102). In some embodiments, FIG. 5 corresponds to instructions stored in a computer memory or computer-readable storage medium (e.g., memory of the application server 140). The memory stores one or more programs configured for execution by the one or more processors. For example, the operations of the method 500 may be performed, at least in part, by the booking probability module 150 and/or the quality estimation module 142. In some embodiments, the steps of the method 500 may be performed by the API server 120, the web server 122, the application server 140, and/or the database server 124.

The method includes, receiving (502) from a client device (e.g., client device 130 of FIG. 1), a search request for a set of listings, the search request including search parameters (e.g., search parameters for the search query set by filters 404). For example, a search request may be for a location (e.g., San Francisco) and the number of guests (e.g., two adults) and the filters applied to this search request may be “maximum listing price”, “free cancellation” and “private room”.

The method further includes, generating (504) a set of listings based on the first search query and the search parameters. For example, the application server 140 of FIG. 1 may be configured to use the search query and search parameters to obtain a set of listings stored in database 126 of FIG. 1 using the search parameters such as location and number of guests, among others.

The method further includes, extracting (506) and grouping price-indicative features and non-price-indicative features for the set of listings. For example, location information for a listing may be extracted and grouped with non-price indicative features while maximum listing price may be extracted and grouped with price indicative features.

The method further includes, separately computing (508) a probability of booking and an estimate of quality (e.g., for each individual listing), by inputting the price-indicative features and non-price-indicative features of the set of listings to trained machine learning models (e.g., affordability module 150 and quality module 142 in FIG. 1) wherein the trained machine learning models predict (i) an affordability metric based on the price-indicative features and (ii) a quality metric based on non-price-indicative features, separately, and wherein (i) the affordability metric and the quality metric are representative of the probability of booking and (ii) the quality metric is representative of the estimate of quality.

In some embodiments, the trained machine learning models includes a first trained deep neural network (e.g., a trained deep neural network in affordability module 150) for predicting the affordability metric and a second trained deep neural network (a trained deep neural network in quality module 142), distinct from the first trained deep neural network, for predicting the quality metric.

In some embodiments, the method includes inputting the price-indicative features to a first deep neural network that is trained to predict affordability, and (ii) inputting the non-price-indicative features to a second deep neural network that is trained to predict quality.

In some embodiments, for each respective listing of the set of listings, the non-price indicative features include at least one of: a location of the respective listing, a neighborhood of the respective listing, a number of bookings in the neighborhood of the respective listing, a number of bookings of the respective listing, a characteristic of the respective listing, a characteristic of bookings in the neighborhood of the respective listing and a number of clicks of the respective listing.

In some embodiments, a non-price indicative feature is a feature regarding a respective listing (e.g., Listing A 408) that is other than a monetary value associated with the respective listing (e.g., Listing A 408).

In some embodiments, indicative features include at least one of: a display price for the respective listing, a historical display price for the respective listing, a service fee for the respective listing and a cleaning fee for the respective listing.

In some embodiments, a price-indicative feature is a feature regarding a respective listing that is a monetary value associated with the respective listing.

In some embodiments, the trained machine learning model is trained to output the quality metric based on price-indicative features in addition to non-price-indicative features of listings, at the time of training.

The method 500 further includes ranking (510) (e.g., ranking 414 of FIG. 4B) the set of listings based on the probability of booking and the estimate of quality. For example, listings UI 400b shows a set of listings ranked 414 based on the probability of booking and the estimate of quality (e.g., P_{booking}+QUALITY).

In some embodiments, the method 600 further includes, computing a probability of quitting a search for the set of listings by inputting the set of listings to a trained machine learning model that is trained by logging last listing in search results viewed by one or more users; and ranking the set of listings further based on the probability of quitting. For example, in FIG. 4A, a user may have viewed listing B 410 and then quit viewing listings UI 400a. As such, computing a probability of quitting listings 400a is computed by inputting listing A 408 into a trained machine learning model.

In some embodiments, ranking the set of listings (e.g., listings 400b, FIG. 4B) comprises computing a final ranking score that weights the quality metric greater than the affordability metric and ranking the set of listings based on the final ranking score. For example, for listing B 410 in FIG. 4B, the quality metric is weighed higher than the affordability metric. As such, the quality metric for listing B 410 is weighed higher than the quality metric for listing A 408.

In some embodiments, ranking the set of listings comprises computing a final ranking score that weights the quality metric approximately twice as much as the affordability metric and ranking the set of listings based on the final ranking score.

It will be understood that, although the terms first, second, etc., are, in some instances, used herein to describe various elements, these elements should not be limited by these terms. These terms are only used to distinguish one element from another. For example, a first widget could be termed a second widget, and, similarly, a second widget could be termed a first widget, without departing from the scope of the various described implementations. The first widget and the second widget are both widgets, but they are not the same condition unless explicitly stated as such.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen to best explain the principles underlying the claims and their practical applications, to thereby enable others skilled in the art to best use the implementations with various modifications as are suited to the particular uses contemplated.

1. A method of optimizing a search listing, the method comprising:
receiving, from a client device, a search request for a set of listings, the search request including search parameters defining a first search query;
generating a set of listings based on the first search query and the search parameters;
extracting price-indicative features and non-price-indicative features for the set of listings;
computing a probability of booking and an estimate of quality, by inputting the price-indicative features and non-price-indicative features of the set of listings to a plurality of trained machine learning models, wherein the plurality of trained machine learning models predicts (i) an affordability metric based on the price-indicative features and (ii) a quality metric based on non-price-indicative features, separately, and wherein (i) the affordability metric and the quality metric are representative of the probability of booking and (ii) the quality metric is representative of the estimate of quality; and
ranking the set of listings based on the probability of booking and the estimate of quality.

2. The method of claim 1, wherein the plurality of trained machine learning models include a first trained deep neural network for predicting the affordability metric and a second trained deep neural network, distinct from the first trained deep neural network, for predicting the quality metric.

3. The method of claim 1, wherein computing the probability of booking comprises (i) inputting the price-indicative features to a first deep neural network that is trained to predict affordability, and (ii) inputting the non-price-indicative features to a second neural network that is trained to predict quality.

4. The method of claim 1, wherein ranking the set of listings comprises computing a final ranking score that weights the quality metric greater than the affordability metric and ranking the set of listings based on the final ranking score.

5. The method of claim 1, wherein ranking the set of listings comprises computing a final ranking score that weights the quality metric approximately twice as much as the affordability metric and ranking the set of listings based on the final ranking score.

6. The method of claim 1, wherein, for each respective listing of the set of listings, the non-price-indicative features include at least one of:
a location of the respective listing;
a neighborhood of the respective listing;
a number of bookings in the neighborhood of the respective listing;
a number of bookings of the respective listing;
a characteristic of the respective listing;
a characteristic of bookings in the neighborhood of the respective listing; and
a number of clicks of the respective listing.

7. The method of claim 1, wherein a non-price-indicative feature is a feature regarding a respective listing that is other than a monetary value associated with the respective listing.

8. The method of claim 1, wherein, for each respective listing of the set of listings, the price-indicative features include at least one of:
a display price for the respective listing;
a historical display price for the respective listing;
a service fee for the respective listing; and
a cleaning fee for the respective listing.

9. The method of claim 1, wherein a price-indicative feature is a feature regarding a respective listing that is a monetary value associated with the respective listing.

10. The method of claim 1, wherein at least one trained machine learning model of the plurality of trained machine learning models is trained to output the quality metric based on price-indicative features in addition to non-price-indicative features of listings.

11. The method of claim 1, further comprising:
computing a probability of quitting a search for the set of listings by inputting the set of listings to a trained machine learning model that is trained by logging last listing in search results viewed by one or more users; and
ranking the set of listings further based on the probability of quitting.

12. A system comprising a server including one or more processors and memory storing one or more programs to be executed by the one or more processors, the one or more programs including instructions for:
receiving, from a client device, a search request for a set of listings, the search request including search parameters defining a first search query;
generating a set of listings based on the first search query and the search parameters;
extracting price-indicative features and non-price-indicative features for the set of listings;
computing a probability of booking and an estimate of quality, by inputting the price-indicative features and non-price-indicative features of the set of listings to a plurality of trained machine learning models, wherein the plurality of trained machine learning models predicts (i) an affordability metric based on the price-indicative features and (ii) a quality metric based on non-price-indicative features, separately, and wherein (i) the affordability metric and the quality metric are representative of the probability of booking and (ii) the quality metric is representative of the estimate of quality; and
ranking the set of listings based on the probability of booking and the estimate of quality.

13. The system of claim 12, wherein the plurality of trained machine learning models include a first trained deep neural network for predicting the affordability metric and a second trained deep neural network, distinct from the first trained deep neural network, for predicting the quality metric.

14. The system of claim 12, wherein computing the probability of booking comprises (i) inputting the price-indicative features to a first deep neural network that is trained to predict affordability, and (ii) inputting the non-price-indicative features to a second deep neural network that is trained to predict quality.

15. The system of claim 12, wherein ranking the set of listings comprises computing a final ranking score that weights the quality metric greater than the affordability metric and ranking the set of listings based on the final ranking score.

16. The system of claim 12, wherein ranking the set of listings comprises computing a final ranking score that weights the quality metric approximately twice as much as the affordability metric and ranking the set of listings based on the final ranking score.

17. The system of claim 12, wherein, for each respective listing of the set of listings, the non-price-indicative features include at least one of:
a location of the respective listing;
a neighborhood of the respective listing;
a number of bookings in the neighborhood of the respective listing;
a number of bookings of the respective listing;
a characteristic of the respective listing;
a characteristic of bookings in the neighborhood of the respective listing; and
a number of clicks of the respective listing.

18. The system of claim 12, wherein a non-price-indicative feature is a feature regarding a respective listing that is other than a monetary value associated with the respective listing.

19. (canceled)

20. A non-transitory computer readable storage medium storing one or more programs configured for execution by a computer system having a display, one or more processors, and memory, the one or more programs comprising instructions for:
receiving, from a client device, a search request for a set of listings, the search request including search parameters defining a first search query;
generating a set of listings based on the first search query and the search parameters;
extracting price-indicative features and non-price-indicative features for the set of listings;
computing a probability of booking and an estimate of quality, by inputting the price-indicative features and non-price-indicative features of the set of listings to a plurality of trained machine learning models, wherein the plurality of trained machine learning models predicts (i) an affordability metric based on the price-indicative features and (ii) a quality metric based on non-price-indicative features, separately, and wherein (i) the affordability metric and the quality metric are representative of the probability of booking and (ii) the quality metric is representative of the estimate of quality; and
ranking the set of listings based on the probability of booking and the estimate of quality.

21. The non-transitory computer readable storage medium of claim 20, wherein at least one trained machine learning model of the plurality of trained machine learning models is trained to output the quality metric based on price-indicative features in addition to non-price-indicative features of listings.
